(19) United States
(12) Patent Application Publication
(10) Pub. No.: US 2026/0340404 A1
(43) Pub. Date: Oct. 29, 2026

(54) ACTIVE CONTINUAL LEARNING METHOD AND SYSTEM USING ACCUMULATED INFORMATIVENESS

(71) Applicant: Samsung Electronics Co., Ltd., Suwon-si (KR)

(72) Inventors: Jaegil Lee, Daejeon-si (KR); Jaehyun Park, Daejeon-si (KR); Dongmin Park, Daejeon-si (KR)

(73) Assignees: Samsung Electronics Co., Ltd., Suwon-si (KR); Korea Advanced Institute of Science and Technology, Daejeon (KR)

(21) Appl. No.: 19/544,900

(22) Filed: Feb. 19, 2026

(30) Foreign Application Priority Data
Apr. 22, 2025 (KR) 10-2025-0052575
Jul. 16, 2025 (KR) 10-2025-0096376

(51) Int. Cl. G06N 3/091

(52) U.S. Cl. CPC G06N 3/091

(57) ABSTRACT

An active continual learning method using accumulated informativeness includes performing active continual learning for a first task based on a first unlabeled task dataset corresponding to the first task, a pretrained model parameter of a neural network model, and a memory dataset prestored in a memory buffer to update the model parameter and expand the memory dataset, and performing active continual learning for a second task based on a second unlabeled task dataset corresponding to the second task, the updated model parameter, and the expanded memory dataset.

### CROSS-REFERENCE TO RELATED APPLICATIONS

This present application claims priority to and the benefit under 35 U.S.C. § 119 (a)-(d) of Korean Patent Application No. 10-2025-0052575, filed on Apr. 22, 2025, in the Korean Intellectual Property Office, and Korean Patent Application No. 10-2025-0096376, filed on Jul. 16, 2025, in the Korean Intellectual Property Office, the entire disclosures of which are incorporated herein by reference.

### FIELD

The disclosure relates to an active continual learning method and system using accumulated informativeness, and more particularly, to a method of sampling a dataset used to train a deep learning model in an environment where an unlabeled dataset is given.

### BACKGROUND

Active learning may refer to a machine learning technique that selectively labels data samples having the most beneficial information for training, to improve model performance in an environment where data labeling is costly. Active learning may aim to enable a model to achieve optimal performance in an environment where a large amount of unlabeled data is provided and a budget available for labeling is limited.

Continual learning may refer to a machine learning technique that enables a model to continuously obtain new information without forgetting past knowledge while learning data related to multiple tasks that are sequentially provided. A major problem with continual learning is catastrophic forgetting, which may refer to a phenomenon where information related to past tasks is lost as the model learns data related to new tasks.

Active continual learning may refer to a machine learning technique that combines active learning and continual learning. Active continual learning may aim to efficiently obtain new knowledge while retaining information related to past tasks and sequentially learning tasks under a limited labeling budget.

In an active continual learning environment, an approach that simply applies an active learning algorithm to a continual learning environment may cause a problem of focusing only on new tasks when sampling data from a dataset. This approach may fail to effectively prevent catastrophic forgetting and degrade overall performance of an artificial intelligence model by prioritizing only learning of data related to new tasks.

### SUMMARY

The disclosure provides an active learning technique which, in an active continual learning environment, enables a model to effectively adapt to new tasks without forgetting knowledge acquired from past tasks, by calculating accumulated informativeness based on a memory buffer and current task data and selecting samples accordingly.

The disclosure is not limited to the aspects mentioned above, and other aspects may be clearly understood by those skilled in the art from the following description.

According to aspects of the disclosure, there is provided a method of sequentially training a neural network model with a plurality of unlabeled datasets corresponding to a plurality of tasks, respectively, performed by a computing system, the method including performing active continual learning for a first task based on a first unlabeled task dataset corresponding to the first task, a pretrained model parameter of the neural network model, and a memory dataset prestored in a memory buffer to update the model parameter and expand the memory dataset, performing active continual learning for a second task based on a second unlabeled task dataset corresponding to the second task, the updated model parameter, and the expanded memory dataset, and after active continual learning for each of the plurality of tasks is completed, outputting a final model parameter corresponding to the neural network model.

According to aspects of the disclosure, there is provided a system for sequentially training a neural network model with a plurality of unlabeled datasets corresponding to a plurality of tasks, respectively, the system including an active continual learning module configured to perform active continual learning for a first task based on a first unlabeled task dataset corresponding to the first task, a pretrained model parameter of the neural network model, and a memory dataset prestored in a memory buffer, and a data management module configured to update the model parameter and expand the memory dataset by performing active continual learning for the first task, wherein the active continual learning module is further configured to perform active continual learning for a second task based on a second unlabeled task dataset corresponding to the second task, the updated model parameter, and the expanded memory dataset, and output a final model parameter corresponding to the neural network model after active continual learning for each of the plurality of tasks is completed.

According to aspects of the disclosure, there is provided a computer-readable non-transitory storage medium for storing instructions that, when executed by at least one processor, cause the at least one processor to sequentially train a neural network model with a plurality of unlabeled datasets corresponding to a plurality of tasks, respectively, the sequential training including performing active continual learning for a first task based on a first unlabeled task dataset corresponding to the first task, a pretrained model parameter of the neural network model, and a memory dataset prestored in a memory buffer to update the model parameter and expand the memory dataset, performing active continual learning for a second task based on a second unlabeled task dataset corresponding to the second task, the updated model parameter, and the expanded memory dataset, and outputting a final model parameter corresponding to the neural network model after active continual learning for each of the plurality of tasks is completed.

### BRIEF DESCRIPTION OF THE DRAWINGS

Embodiments will be more clearly understood from the following detailed description taken in conjunction with the accompanying drawings in which:

FIG. 1 is a block diagram of a system according to embodiments;

FIG. 2 is a diagram illustrating an active continual learning method of a system, according to embodiments;

FIG. 3 is a graph illustrating a sample selection method based on accumulated informativeness of the system, according to embodiments;

FIG. 4 is a block diagram of the system according to embodiments;

FIG. 5 is a diagram illustrating Fisher information embedding vectors according to embodiments;

FIG. 6 is a diagram illustrating sampling criteria of a dataset according to embodiments;

FIG. 7 is a flowchart illustrating an active continual learning method of the system according to embodiments;

FIG. 8 is a flowchart illustrating the active continual learning method of the system according to embodiments;

FIG. 9 is a flowchart illustrating the active continual learning method of a system according to embodiments; and

FIG. 10 is a block diagram of a computer system according to embodiments.

### DETAILED DESCRIPTION

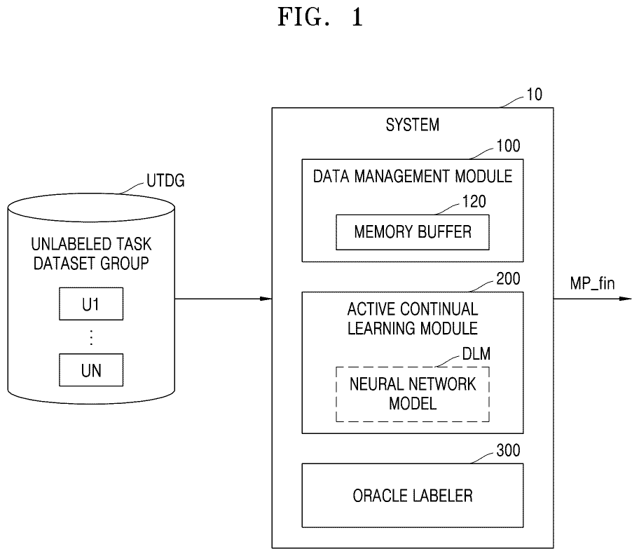

FIG. 1 is a block diagram of a system 10 according to embodiments.

Referring to FIG. 1, the system 10 may include a data management module 100, an active continual learning module 200, and an Oracle labeler 300.

The system 10 may perform active continual learning by sequentially obtaining an unlabeled task dataset from an unlabeled task dataset group UTDG and training a neural network model DLM based on the obtained unlabeled task dataset and a memory dataset stored in a memory buffer 120. In some embodiments, the system 10 may be referred to as a computing system or an active continual learning system.

In embodiments, the neural network model DLM may include a neural network model for classification. A final layer of the neural network model DLM may include a layer that outputs the probability for each class through a sigmoid function or a softmax function. Thus, the neural network model DLM may output the probability that input data belongs to each class. In some embodiments, the final layer of the neural network model DLM may include a linear classification layer.

Herein, active continual learning of the system 10 may be based on accumulated informativeness. Specifically, the accumulated informativeness herein may refer to an integration of the following two aspects of informativeness in a balanced manner. The informativeness of the first aspect may include informativeness that contributes to the ability of the neural network model DLM to rapidly learn new tasks, and the informativeness of the second aspect may include informativeness that contributes to the ability of the neural network model DLM to retain previously-learned knowledge (i.e., informativeness that contributes to the ability to prevent catastrophic forgetting). The accumulated informativeness may be specifically defined and measured using the Fisher information matrix. The Fisher information matrix may be obtained by performing calculation based on a model parameter of the neural network model DLM. For example, the Fisher information matrix may be obtained by the system 10 calculating the following Equation 1.

$$I ( θ ; S ) = - \frac{1}{\vert S \vert} {\sum }_{x ∈ S} {\sum }_{y ∈ C} p ( y \vert x ; θ ) {∇}_{θ} log p ( y \vert x ; θ ) {∇}_{θ}^{T} log p ( y \vert x ; θ ) ∈ {ℝ}^{\vert θ \vert \times \vert θ \vert} \qquad [ Equation 1 ]$$

I(θ; S) may denote the Fisher information matrix for any subset S (e.g., a first labeled task dataset sampled from a first unlabeled task dataset U1), wherein θ may denote the vector of all learnable weights and biases of the neural network model DLM. C may denote the total number of classes that the neural network model DLM must classify, e.g., the number of neurons (or nodes) in the final layer of the neural network model DLM. ∇_{θ} log p(y|x; θ) may denote a gradient vector of a score function.

$${∇}_{θ}^{T} log p ( y \vert x ; θ )$$

may refer to the transpose of the gradient vector. I(θ; S) may denote a covariance matrix of the score function.

The unlabeled task dataset group UTDG may include a plurality of unlabeled task datasets U1 to UN, where N is a natural number of 2 or greater. For example, the unlabeled task dataset group UTDG may include first to N^{th} unlabeled task datasets U1 to UN. The data (e.g., image data) included in the unlabeled task dataset group UTDG may include unlabeled data.

Each of the plurality of unlabeled task datasets U1 to UN may include a dataset having a different data distribution from one another. For example, the first unlabeled task dataset U1 may include a dataset related to a first task. The second unlabeled task dataset U2 may include a dataset related to a second task. The first task and the second task may have different data distributions. For example, the first task may refer to a task of classifying dog and cat images, and the second task may refer to a task of classifying horse and deer images. In this case, classifying the data in the first task and classifying the data in the second task may have different criteria.

The data distribution may refer to a probabilistic representation of the distribution or pattern of data within a particular dataset. For example, in the case of an image dataset, the data distribution may include the composition of visual features (e.g., color, shape, texture) in each image, the frequency of occurrence of objects to be classified (e.g., cats, dogs, cars), or the distribution of such features in a data space. Having different data distributions may mean that each task dataset has unique features, class compositions, or statistical characteristics.

The data management module 100 may obtain an unlabeled task dataset from the unlabeled task dataset group UTDG and sample a query dataset from the obtained unlabeled task dataset. The data management module 100 may expand the query dataset according to active learning results of the active continual learning module 200. In addition, the data management module 100 may include the memory buffer 120 for storing and managing a labeled dataset of past tasks.

The active continual learning module 200 may be configured to perform active continual learning for the current task based on the unlabeled task dataset corresponding to the current task, the pretrained model parameter of the neural network model DLM, and the memory dataset prestored in the memory buffer 120.

In embodiments, the neural network model DLM may include, but is not limited to, various types of neural network models, such as a convolutional neural network (CNN) including ResNet, GoogLeNet, AlexNet, VGGNet, a region with convolutional neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, a transformer, and a vision transformer.

The active continual learning module 200 may update the model parameter by training the neural network model DLM based on the pretrained model parameter and the labeled task dataset.

In addition, using the updated model parameter, the active continual learning module 200 may calculate Fisher information embedding vectors based on the unlabeled task dataset and the memory dataset obtained from the data management module 100.

In addition, the active continual learning module 200 may evaluate fitness of samples using the Fisher information embedding vectors and select optimal samples within a preset labeling budget.

The Oracle labeler 300 may assign labels to a query dataset. The data labeled by the Oracle labeler 300 may be utilized for training the neural network model DLM.

In embodiments, the Oracle labeler 300 may be located outside the system 10.

In embodiments, the Oracle labeler 300 may refer to a manual labeling process performed by a specialist in a particular field (e.g., a medical imaging analyst and a semiconductor defect inspector). Alternatively, the Oracle labeler 300 may refer to a pre-trained or validated external automatic labeling system that performs labeling corresponding to input samples as the samples are input.

After active continual learning is completed for each of the plurality of tasks, the system 10 may output a final model parameter MP_fin corresponding to the neural network model DLM.

In embodiments, the system 10 may perform an inference (e.g., classification) operation on an input image based on the final model parameter MP_fin during an inference stage using the neural network model DLM.

In embodiments, the data management module 100 and the active continual learning module 200 may be implemented in various forms and provided in the system 10. For example, the data management module 100 and the active continual learning module 200 may be implemented as hardware (HW), such as a control circuit for performing various processes related to active continual learning, according to embodiments. Alternatively, the data management module 100 and the active continual learning module 200 may be implemented as software (SW) including a program. In this case, a processor may perform various processes related to active continual learning, according to embodiments, by executing the data management module 100 and the active continual learning module 200 loaded in memory. Alternatively, the data management module 100 and the active continual learning module 200 may be implemented as a combination of HW and SW.

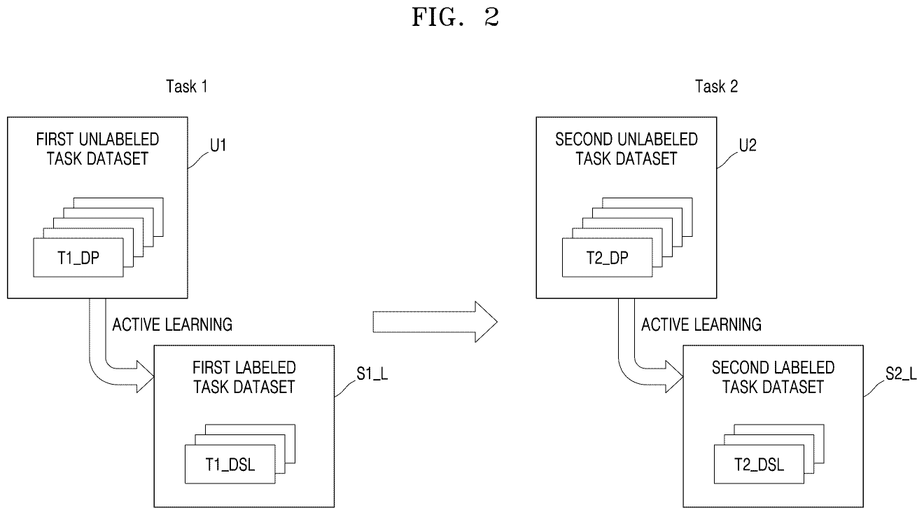

FIG. 2 is a diagram illustrating an active continual learning method of the system 10, according to embodiments. FIG. 2 may be described with reference to FIG. 1, and redundant descriptions may be omitted.

In FIG. 2, for convenience of description, it is assumed that the system 10 performs active continual learning for the first task and the second task.

Referring to FIG. 2, the first task may include a task related to the first unlabeled task dataset U1 among datasets included in the unlabeled task dataset group UTDG of FIG. 1.

The first unlabeled task dataset U1 may include a plurality of first task samples T1_DP. In embodiments, each of the plurality of first task samples T1_DP may include image data.

Hereinafter, it is assumed that a feature represented by samples included in the first unlabeled task dataset U1 is a first feature and a feature represented by samples included in the second unlabeled task dataset U2 is a second feature.

The system 10 may obtain a first labeled task dataset S1_L by performing active learning based on the first unlabeled task dataset U1. The first labeled task dataset S1_L may include samples obtained under the preset labeling budget. That is, the samples included in the first labeled task dataset S1_L may be configured to enable the neural network model DLM to learn information to be learned through the first task (e.g., the first feature) in a balanced manner while retaining learning information related to tasks prior to the first task. For example, the first labeled task dataset S1_L may include a plurality of first labeled task samples T1_DSL. The number of samples included in the first labeled task dataset S1_L may be less than the number of samples included in the first unlabeled task dataset U1.

In embodiments, the system 10 may sample a subset of samples from the first unlabeled task dataset U1. The samples sampled from the first unlabeled task dataset U1 may be labeled by the Oracle labeler 300. The number of samples sampled from the first unlabeled task dataset U1 may be determined according to the preset labeling budget. After being sampled from the first unlabeled task dataset U1, a set of samples labeled by the Oracle labeler 300 may be referred to as the first labeled task dataset S1_L.

In embodiments, the first labeled task dataset S1_L may be obtained by repeatedly performing active learning according to a preset active learning round.

The system 10 may update the model parameter of the neural network model DLM by training the neural network model DLM based on the first labeled task dataset S1_L. In this case, the updating of the model parameter may mean that the neural network model DLM learns the first feature, which is a feature related to the first task.

Herein, the fact that learning for the first task is completed may indicate that the model parameter of the neural network model DLM is updated by considering all samples included in the first labeled task dataset S1_L.

After learning for the first task is completed, learning for the next task, i.e., the second task, may be performed sequentially. The second task may include a task related to the second unlabeled task dataset U2 among datasets included in the unlabeled task dataset group UTDG of FIG. 1.

The second unlabeled task dataset U2 may include a plurality of second task samples T2_DP. In embodiments, each of the plurality of second task samples T2_DP may include image data.

The system 10 may obtain a second labeled task dataset S2_L by performing active learning based on the second unlabeled task dataset U2. The second labeled task dataset S2_L may include samples obtained under the preset labeling budget. That is, the samples included in the second labeled task dataset S2_L may be configured to enable the neural network model DLM to learn information to be learned through the second task (e.g., the first feature) in a balanced manner while retaining learning information related to tasks prior to the second task (e.g., the second feature). For example, the second labeled task dataset S2_L may include a plurality of second labeled task samples T2_DSL. The number of samples included in the second labeled task dataset S2_L may be less than the number of samples included in the second unlabeled task dataset U2.

The system 10 obtains the second labeled task dataset S2_L and trains the neural network model DLM using the second labeled task dataset S2_L in the same manner as the system 10 obtains the first labeled task dataset S1_L and trains the neural network model DLM using the first labeled task dataset S1_L. Therefore, redundant descriptions may be omitted.

After learning for the second task is completed, learning for the next task, which is a third task, may be performed sequentially. Since subsequent operations are similar to those of the first task and the second task, redundant descriptions may be omitted.

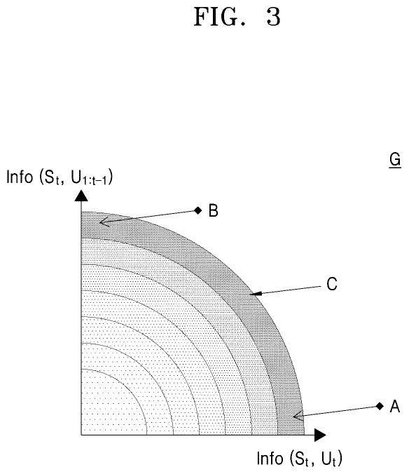

FIG. 3 is a graph illustrating a sample selection method based on accumulated informativeness of the system 10, according to embodiments. FIG. 3 may be described with reference to FIGS. 1 and 2, and redundant descriptions may be omitted.

Referring to FIG. 3, a first axis (i.e., the horizontal axis) of a graph G may represent informativeness for a current task of a selected sample. In other words, the first axis of the graph G represents an extent to which a labeled task dataset Sₜ at a time point t, which is the current time point, is informative for an unlabeled task dataset Uₜ. Hereinafter, a task at the time point t may refer to a task t.

For example, when the labeled task dataset Sₜ satisfies the following Equation 2, the labeled task dataset Sₜ may enable the neural network model DLM to better learn features of samples included in the unlabeled task dataset Uₜ. In this case, the informativeness of the labeled task dataset Sₜ may correspond to a point A on the graph G.

$${arg max}_{{S}_{t}} Info ( {S}_{t} , {U}_{t} ) \qquad [ Equation 2 ]$$

A second axis (i.e., the vertical axis) of the graph G may represent informativeness for a past task of the sample. In other words, the second axis of the graph G represents an extent to which the labeled task dataset Sₜ at the time point t, which is the current time point, is informative for a past unlabeled data pool U_{1:t-1}.

Herein, the past unlabeled data pool U_{1:t-1} may refer to a set of unlabeled task datasets obtained by considering the past time point with respect to the current time point t (i.e., from time point 1 to time point t−1).

For example, when the labeled task dataset Sₜ satisfies the following Equation 3, the labeled task dataset Sₜ may enable the neural network model DLM to better learn features of samples included in the past unlabeled data pool U_{1:t-1}. In this case, the labeled task dataset Sₜ may correspond to a point B on the graph G.

$${arg max}_{{S}_{t}} Info ( {S}_{t} , {U}_{1 : t - 1} ) \qquad [ Equation 3 ]$$

The system 10 may sample the labeled task dataset Sₜ from the unlabeled task dataset Uₜ. At this time, in order for the neural network model DLM to learn informativeness for the current task and informativeness for the past task in a balanced manner, it is necessary to sample a dataset with large accumulated informativeness. In this case, the informativeness of the labeled task dataset Sₜ may correspond to a point C on the graph G. Herein, the accumulated informativeness at the time point t may be defined as the following Equation 4.

ACCUINFO(Sₜ,U_{1:t})=f(Info(Sₜ,Uₜ),Info(Sₜ,U_{1:t-1})) [Equation 4]

f may refer to any function capable of performing weighted combination of the two informativeness values. In embodiments, Info(Sₜ, Uₜ) and Info(Sₜ, U_{1:t-1}) may each be represented as a Fisher information matrix.

A reference metric for calculating the impact of the labeled task dataset Sₜ on the accumulated informativeness may include a target Fisher information matrix. The target Fisher information matrix may be defined as the following Equation 5.

I(θₜ;U_{1:t})=λ·I(θₜ;U_{1:t-1})+(1−λ)·I(θₜ;Uₜ) [Equation 5]

I(θₜ; U_{1:t-1}) may denote a Fisher information matrix representing past information. I(θₜ; Uₜ) may denote a Fisher information matrix representing new information. A balancing parameter λ may be defined according to the following Equation 6.

$$λ = \frac{\vert {U}_{1 : t - 1} \vert}{\vert {U}_{1 : t} \vert} \qquad [ Equation 6 ]$$

In other words, the balancing parameter A may be defined as the ratio of the size of unlabeled datasets used for training up to the past time point (e.g., time point t−1) to the size of unlabeled datasets used for training up to the current time point (e.g., time point t). The balancing parameter λ may have a value between 0 and 1. The balancing parameter λ approaching 1 may indicate that active continual learning is effective in retaining past informativeness. The balancing parameter λ approaching 0 may indicate that active continual learning is effective in learning new tasks.

A matrix corresponding the Fisher information matrix I(θₜ; U_{1:t}) representing the past information may be stored in the memory buffer 120.

The system 10 according to embodiments may include the memory buffer 120. When utilizing the memory buffer 120, Equation 5 may be approximated by the following Equation 7.

I(θₜ;U_{1:t})≈I(θₜ;Mₜ,Uₜ)=λ·I(θₜ;Mₜ)+(1−λ)·I(θₜ;Uₜ) [Equation 7]

Mₜ may refer to a memory dataset stored in the memory buffer 120 at the time point t. That is, by utilizing the memory dataset Mₜ, a matrix I(θₜ; Mₜ) approximating the Fisher information matrix I(θₜ; U_{1:t}) representing the past information may be obtained. Hereinafter, the Fisher information matrix representing the past information may be referred to as the matrix I(θₜ; Mₜ).

As shown in Equation 7, massive computational resources may be required to obtain the Fisher information matrix. The system 10 according to embodiments may reduce the computational load required to calculate the accumulated informativeness by calculating the Fisher information embedding vector, as shown in Equation 8, instead of directly calculating the Fisher information matrix.

$$F ( {θ}_{t} ; D ) = \frac{1}{\vert D \vert} {\sum }_{x ∈ D} f ( {θ}_{t} ; x ) \qquad [ Equation 8 ]$$

D may refer to any dataset. x may refer to a sample belonging to any dataset D. ƒ(θₜ; x) may be defined as the following Equation 9. Elements of the Fisher information embedding vector F(θₜ; D) may correspond to diagonal components of the Fisher information matrix (e.g., I(θₜ; D)), respectively.

$$f ( {θ}_{t} ; x ) = {\sum }_{y ∈ C} {p ( y \vert x ; {θ}_{t} ) [ {∇}_{{θ}_{t}} log p ( y \vert x ; {θ}_{t} ) ]}^{2} ∈ {ℝ}^{\vert {θ}_{t} \vert} \qquad [ Equation 9 ]$$

The dimensions of the Fisher information embedding vector may be |θₜ| and may be less than |θₜ|² which is the dimensions of the Fisher information matrix.

In addition, when the neural network model DLM of the system 10 according to embodiments is a model for solving classification problems, the system 10 may reduce the required computational load by considering only weights and biases between the final layer and the penultimate layer of the neural network model DLM when calculating the Fisher information embedding vector. Therefore, in Equations 8 and 9, et may be obtained by considering only parameters corresponding to the weights and biases between the final layer and the penultimate layer among the model parameters of the neural network model DLM.

When the Fisher information embedding vector is obtained, Equation 5 may be defined using the Fisher information embedding vector, as shown in the following Equation 10, instead of the Fisher information matrix.

F(θₜ;Mₜ,Uₜ)=λ·F(θₜ;Mₜ)+(1−λ)·F(θₜ;Uₜ) [Equation 10]

F(θₜ; Mₜ, Uₜ) may denote a target Fisher information embedding vector.

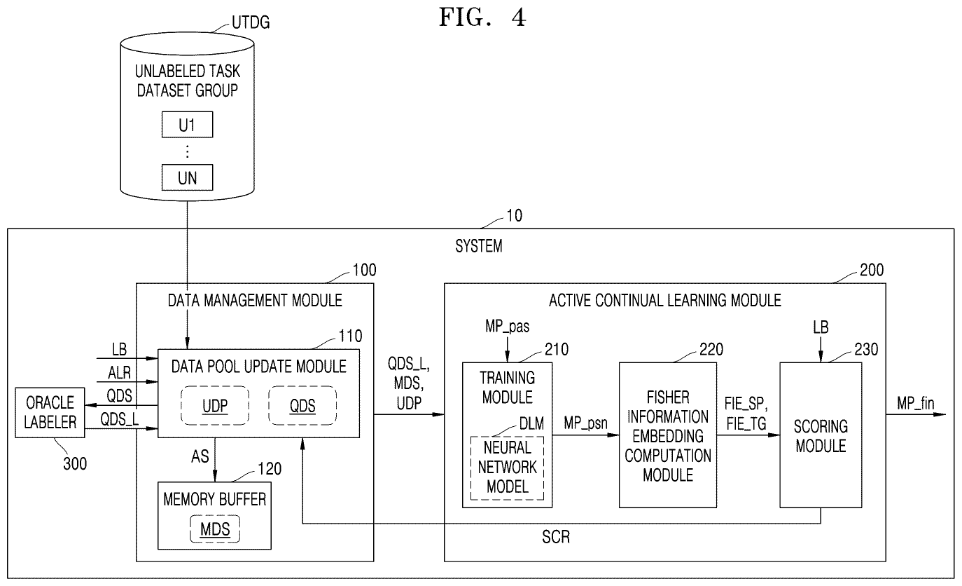

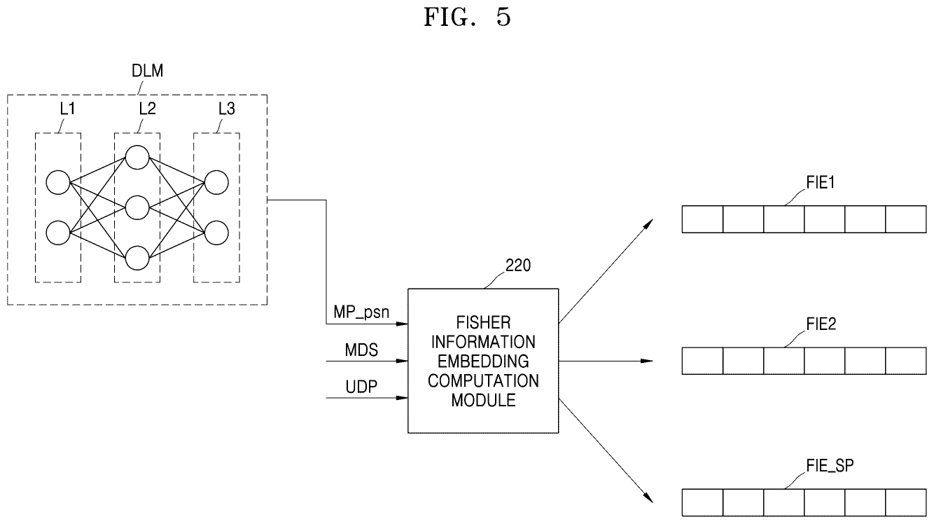

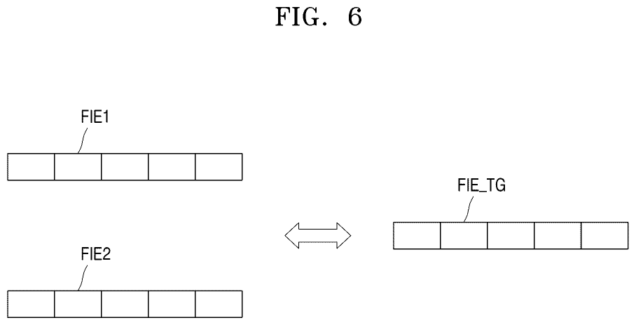

FIG. 4 is a block diagram of the system 10 according to embodiments. FIG. 5 is a diagram illustrating Fisher information embedding vectors according to embodiments. FIG. 6 is a diagram illustrating sampling criteria of a dataset according to embodiments. FIGS. 4 to 6 may be described with reference to FIGS. 1 to 3, and redundant descriptions may be omitted.

Referring to FIG. 4, the system 10 may include the data management module 100, the active continual learning module 200, and the Oracle labeler 300.

The data management module 100 may include a data pool update module 110 and the memory buffer 120. The data management module 100 may obtain an unlabeled task dataset Uₜ from the unlabeled task dataset group UTDG. In FIG. 4, the unlabeled task dataset Uₜ may include a dataset associated with the task t (i.e., the task at time point t). The task t may include any one task among the first task to the N^{th} task.

The data pool update module 110 may sample a query dataset QDS from the unlabeled task dataset Uₜ. The query dataset QDS may be sampled from the unlabeled task dataset Uₜ by considering a labeling budget LB. For example, the number of samples included in the query dataset QDS may correspond to the labeling budget LB.

In embodiments, the labeling budget LB may include a preset value stored in the system 10 or may include a value input from an external source.

The data pool update module 110 may generate an unlabeled data pool UDP based on the unlabeled task dataset Uₜ and the query dataset QDS. For example, the unlabeled data pool UDP may be defined as a portion of the unlabeled task dataset Uₜ excluding the query dataset QDS. In other words, the unlabeled data pool UDP may be defined as a set difference of the unlabeled task dataset Uₜ and the query dataset QDS.

The data pool update module 110 may provide the query dataset QDS to the Oracle labeler 300. The Oracle labeler 300 may perform a labeling operation on the query dataset QDS and may generate and provide a labeled task dataset QDS_L to the data pool update module 110.

A memory dataset MDS may be stored in the memory buffer 120. The memory dataset MDS may be a set of labeled task datasets up to a time point prior to the current time point. For example, when the current task is a third task, the memory dataset MDS may include a labeled task dataset corresponding to the first task and a labeled task dataset corresponding to the second task.

The data management module 100 may provide the labeled task dataset QDS_L, the memory dataset MDS, and the unlabeled data pool UDP to the active continual learning module 200. The data management module 100 may receive a decision result SCR from the active continual learning module 200. The decision result SCR may include samples newly selected from the unlabeled data pool UDP by the active continual learning module 200.

Based on the decision result SCR received from the active continual learning module 200, the data pool update module 110 may update the query dataset QDS and the unlabeled data pool UDP by expanding the query dataset QDS and reducing the unlabeled data pool UDP.

In embodiments, the newly selected samples included in the decision result SCR may be added to the query dataset QDS. Accordingly, the query dataset QDS may be expanded. The newly selected samples included in the decision result SCR may be removed from the unlabeled data pool UDP. Accordingly, the unlabeled data pool UDP may be reduced.

The data pool update module 110 may provide the expanded query dataset QDS back to the Oracle labeler 300 and obtain the expanded labeled task dataset QDS_L from the Oracle labeler 300.

The data pool update module 110 may provide the expanded labeled task dataset QDS_L and the reduced unlabeled data pool UDP back to the active continual learning module 200.

In embodiments, a series of processes in which the data pool update module 110 receives the decision result SCR from the active continual learning module 200 and updates the query dataset QDS and the unlabeled data pool UDP may be referred to as an active learning process. The active learning process may be performed repeatedly for a preset number of active learning rounds ALR.

In embodiments, the number of active learning rounds ALR may be a preset value stored in the system 10 or may be a value input from the external source.

The data management module 100 may determine that learning for the task t is completed when the query dataset QDS and the unlabeled data pool UDP are repeatedly updated for the preset number of active learning rounds ALR. The data pool update module 110 may expand the memory dataset MDS by storing, in the memory buffer 120, the labeled task dataset QDS_L at the time point when learning for the task t is completed. For example, before learning for the fourth task is initiated, following completion of learning for the third task, the memory dataset MDS may include a labeled task dataset corresponding to the first task, a labeled task dataset corresponding to the second task, and a labeled task dataset corresponding to the third task.

The active continual learning module 200 may include a training module 210, a Fisher information embedding computation module 220, and a scoring module 230.

The training module 210 may train the neural network model DLM based on a pretrained model parameter MP_pas of the neural network model DLM and the labeled task dataset QDS_L received from the data management module 100. As a result, the pretrained model parameter MP_pas of the neural network model DLM may be updated to a model parameter MP_psn. In some embodiments, the pretrained model parameter MP_pas may be referred to as a past model parameter.

Training the neural network model DLM may include a process of repeatedly adjusting multiple parameters (e.g., weights and biases) contained within the neural network model DLM. The model parameter MP_psn may refer to multiple parameters included in the neural network model DLM. Specifically, the training module 210 may input the labeled task dataset QDS_L to the neural network model DLM to calculate the difference between a predicted result (i.e., predicted label) and an actual label through a loss function (e.g., cross-entropy function) and update the parameters using an optimization algorithm, such as gradient descent, to minimize the difference. Therefore, the neural network model DLM may be trained to adapt to data related to a new task while effectively retaining information related to the past task embedded in the pretrained model parameter MP_pas.

In some embodiments, the model parameter MP_psn may be referred to as a current model parameter.

Referring to FIGS. 4 and 5, the Fisher information embedding computation module 220 may obtain the Fisher information embedding vector based on the model parameter MP_psn, the memory dataset MDS, and the unlabeled data pool UDP.

In some embodiments, the model parameter MP_psn utilized by the Fisher information embedding computation module 220 may be obtained by considering only the parameters for the last two layers of the neural network model DLM, thereby reducing the computational load required to obtain the Fisher information embedding vector. Hereinafter, for convenience of description, it is assumed that the neural network model DLM includes three layers: a first layer, a second layer, and a third layer. In this case, the first layer may include two neurons, the second layer may include three neurons, and the third layer may include two neurons. It is assumed that the number of parameters obtained by considering only the last two layers (i.e., the second layer and the third layer) is a total of six weights.

The Fisher information embedding computation module 220 may obtain a first Fisher information embedding vector FIE1 by performing operations according to Equation 8 based on the model parameter MP_psn and the memory dataset MDS.

The Fisher information embedding computation module 220 may obtain a second Fisher information embedding vector FIE2 by performing operations according to Equation 8 based on the model parameter MP_psn and the unlabeled data pool UDP.

Referring to FIGS. 4 and 6, the Fisher information embedding computation module 220 may obtain a target Fisher information embedding vector FIE_TG by performing operations according to Equation 10 based on the first Fisher information embedding vector FIE1 and the second Fisher information embedding vector FIE2.

Referring back to FIGS. 4 and 5, the Fisher information embedding computation module 220 may obtain a sample Fisher information embedding vector FIE_SP by performing operations according to Equation 8 based on the model parameter MP_psn and any one sample belonging to the unlabeled data pool UDP.

The Fisher information embedding computation module 220 may provide the sample Fisher information embedding vector FIE_SP and the target Fisher information embedding vector FIE_TG to the scoring module 230.

The scoring module 230 may determine, based on the sample Fisher information embedding vector FIE_SP, which sample from the unlabeled data pool UDP can maximize the accumulated informativeness according to Equation 4.

In embodiments, the scoring module 230 may select samples from the unlabeled data pool UDP to be added to the query dataset QDS, based on a first score and a second score. The number of newly selected samples may correspond to the labeling budget LB.

The first score may be a metric representing a similarity between the sample Fisher information embedding vector FIE_SP and the target Fisher information embedding vector FIE_TG. In some embodiments, the first score may be referred to as a distribution score. The first score may be calculated according to the following Equation 11.

exp(− [symbol] _{JS}(σ(F_{U,i})∥σ(Fₜ)) [Equation 11]

U may denote the unlabeled data pool UDP. Fₜ may denote the target Fisher information embedding vector FIE_TG. F_{U,i} may refer to the sample Fisher information embedding vector FIE_SP (e.g., any sample i selected from the unlabeled data pool UDP). σ may refer to a softmax function. [symbol] _{JS}(⋅∥⋅) may refer to a Jensen-Shannon divergence. Since the Jensen-Shannon divergence is one of the standard methods in the field of information theory for measuring the similarity or dissimilarity between two probability distributions, detailed description thereof may be omitted.

The second score may include a metric representing the informativeness of the sample Fisher information embedding vector FIE_SP. In some embodiments, the second score may be referred to as a magnitude score. The second score may be calculated according to the following Equation 12.

∥F_{U,i}∥₂ [Equation 12]

Herein, Equation 12 may denote the L2 norm for F_{U,i}. In some embodiments, the L2 norm may be referred to as the Euclidean norm.

The scoring module 230 may generate a first sampling group by performing sampling from the unlabeled data pool UDP based on the similarity between the target Fisher information embedding vector FIE_TG and each of the samples included in the unlabeled data pool UDP.

In embodiments, the scoring module 230 may sample the samples from the unlabeled data pool UDP based on the first score. At this time, the scoring module 230 may sample a greater number of samples than the labeling budget LB (e.g., twice the labeling budget LB). The scoring module 230 may generate the first sampling group by sampling the samples that satisfy Equation 13. In other words, the scoring module 230 may sample, from the unlabeled data pool UDP, a greater number of samples having the high first score than the labeling budget LB.

$$S G 1 = {arg max}_{i ∈ \{ 0 , 1 , … , \vert U \vert - 1 \}} {}^{( 2 b )} exp ( - {𝒟}_{JS} ( σ ( {F}_{U , i} ) \vert \vert σ ( {F}_{t} ) ) \qquad [ Equation 13 ]$$

The scoring module 230 may generate a second sampling group by performing sampling once again from the first sampling group, based on the size of each of the samples included in the first sampling group. In other words, the scoring module 230 may sample, from the first sampling group, a number of samples having the high second score corresponding to the labeling budget LB.

In embodiments, the scoring module 230 may sample the samples from the first sampling group based on the second score. At this time, the scoring module 230 may sample a number of samples corresponding to the labeling budget LB. The scoring module 230 may generate the second sampling group by sampling the samples that satisfy Equation 14.

$$SG 2 = {arg max}_{i ∈ SG 1} {}^{( b )} {‖ {F}_{U , i} ‖}_{2} \qquad [ Equation 14 ]$$

The scoring module 230 may provide the decision result SCR to the data management module 100. The decision result SCR may include a plurality of samples selected from the unlabeled data pool UDP. The number of samples included in the decision result SCR may correspond to the labeling budget LB. Specifically, the samples included in the decision result SCR may correspond to the second sampling group.

The data pool update module 110 may expand the query dataset QDS by adding samples included in the second sampling group to the query dataset QDS. The data pool update module 110 may reduce the unlabeled data pool UDP by removing the samples included in the second sampling group from the unlabeled data pool UDP.

In embodiments, when learning for all unlabeled task datasets included in the unlabeled task dataset group UTDG is completed, the active continual learning module 200 may output the final model parameter MP_fin representing the model parameter of the neural network model DLM at that time point.

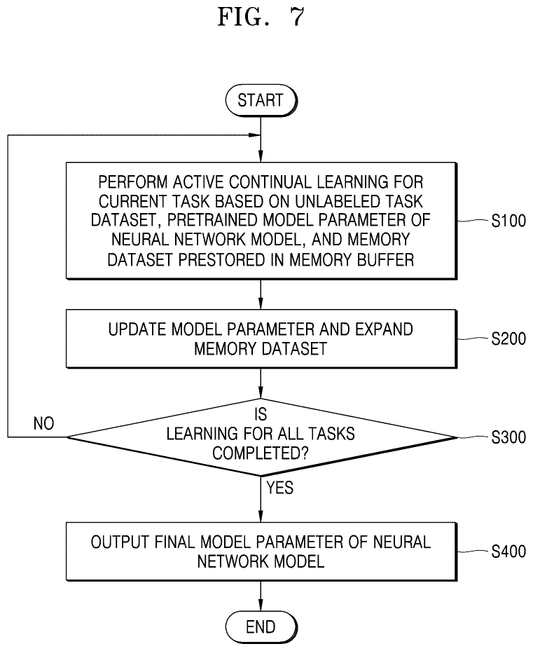

FIG. 7 is a flowchart illustrating an active continual learning method of the system 10 according to embodiments. FIG. 7 may be described with reference to FIGS. 1 to 6, and duplicate description may be omitted.

Referring to FIG. 7, in operation S100, the system 10 may perform active continual learning for the current task based on the unlabeled task dataset Uₜ, the pretrained model parameter MP_pas of the neural network model DLM, and the memory dataset MDS prestored in the memory buffer 120.

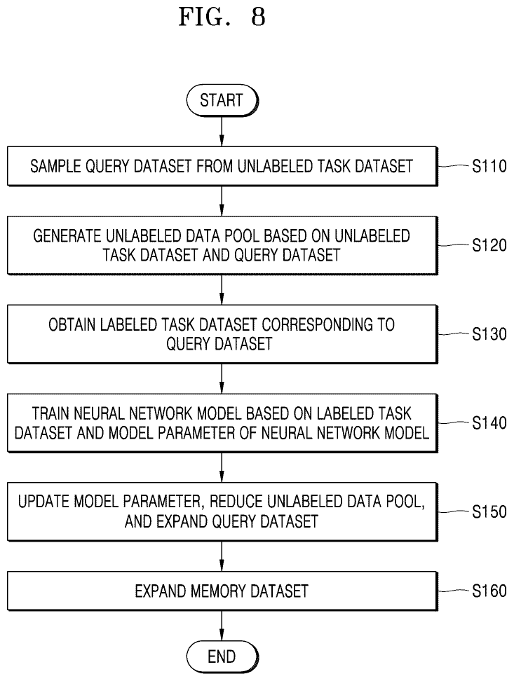

In embodiments, the system 10 may perform active continual learning for the first task based on the first unlabeled task dataset U1 corresponding to the first task, the pretrained model parameter MP_pas of the neural network model DLM, and the memory dataset MDS prestored in the memory buffer 120. A detailed description of operation S110 is described below with reference to FIG. 8.

In operation S200, by performing active continual learning according to operation $110, the system 10 may update the pretrained model parameter MP_pas to the model parameter MP_psn and expand the memory dataset MDS.

In embodiments, the system 10 may expand the memory dataset MDS when active continual learning for the first task is completed.

In operation S300, the system 10 may determine whether active continual learning has been completed for all tasks. That is, the system 10 may determine whether active continual learning has been completed for all unlabeled task datasets included in the unlabeled task dataset group UTDG.

In embodiments, when active continual learning is not completed for all tasks, the system 10 may sequentially perform active continual learning for the next task. For example, when active continual learning for the first task is completed and the second task is the next task, the system 10 may perform active continual learning for the second task based on the second unlabeled task dataset U2 corresponding to the second task, the pretrained model parameter MP_pas, and the memory dataset MDS.

In operation S400, when active continual learning for all tasks is completed, the system 10 may output the final model parameter MP_fin of the neural network model DLM.

FIG. 8 is a flowchart illustrating the active continual learning method of the system 10 according to embodiments. Specifically, FIG. 8 is a flowchart illustrating operation S100 of FIG. 7 in detail. FIG. 8 may be described with reference to FIGS. 1 to 7, and redundant descriptions may be omitted.

Referring to FIG. 8, in operation S110, the system 10 may sample the query dataset QDS from the unlabeled task dataset Uₜ.

In operation S120, the system 10 may generate the unlabeled data pool UDP based on the unlabeled task dataset Uₜ and the query dataset QDS.

In operation S130, the system 10 may obtain the labeled task dataset QDS_L corresponding to the query dataset QDS through the Oracle labeler 300.

In operation S140, the model parameter MP_psn may be generated by training the neural network model DLM based on the labeled task dataset QDS_L and the pretrained model parameter MP_pas.

In operation S150, the system 10 may update the model parameter MP_psn, reduce the unlabeled data pool UDP, and expand the query dataset QDS by performing active learning for the current task based on the model parameter MP_psn, the memory dataset MDS, the unlabeled data pool UDP, and the query dataset QDS.

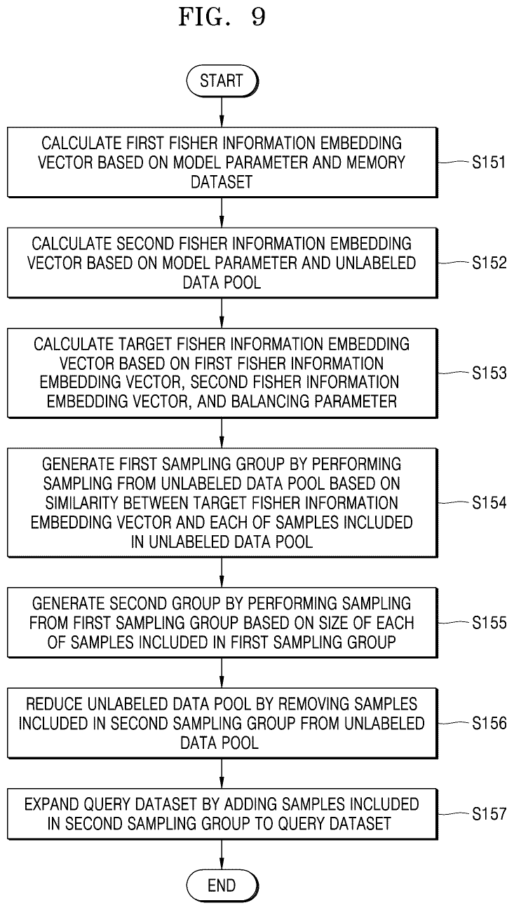

In embodiments, the system 10 may repeatedly perform the active learning according to operation S150 for a preset number of active learning rounds ALR. A detailed description of operation S150 is described below with reference to FIG. 9.

In operation S160, the system 10 may expand the memory dataset MDS by storing, in the memory buffer 120, data obtained by labeling the samples corresponding to the expanded query dataset according to operation S150.

In embodiments, the system 10 may obtain a labeled expanded query dataset corresponding to the expanded query dataset through the Oracle labeler 300.

In embodiments, the system 10 may expand the memory dataset MDS by storing the labeled expanded query dataset in the memory buffer 120.

FIG. 9 is a flowchart illustrating the active continual learning method of the system 10 according to embodiments. Specifically, FIG. 9 is a flowchart illustrating operation S150 of FIG. 8 in detail. FIG. 9 may be described with reference to FIGS. 1 to 8, and redundant descriptions may be omitted.

Referring to FIG. 9, in operation S151, the system 10 may calculate the first Fisher information embedding vector FIEL based on the model parameter MP_psn and the memory dataset MDS.

In embodiments, elements of the first Fisher information embedding vector FIE1 may respectively correspond to diagonal components of the first Fisher information matrix defined by the model parameter MP_psn and the memory dataset MDS.

In operation S152, the system 10 may calculate the second Fisher information embedding vector FIE2 based on the model parameter MP_psn and the unlabeled data pool UDP.

In embodiments, elements of the second Fisher information embedding vector FIE2 may respectively correspond to diagonal components of the second Fisher information matrix defined by the model parameter MP_psn and the unlabeled data pool UDP.

In operation S153, the system 10 may calculate the target Fisher information embedding vector FIE_TG based on the first Fisher information embedding vector FIE1, the second Fisher information embedding vector FIE2, and the balancing parameter.

In operation S154, the system 10 may generate the first sampling group by performing sampling, from the unlabeled data pool UDP, based on the similarity between the target Fisher information embedding vector FIE_TG and each of the samples included in the unlabeled data pool UDP.

In embodiments, calculating the similarity of each of the samples may refer to calculating the first score through Equation 11.

In operation S155, the system 10 may generate the second sampling group by performing sampling, from the first sampling group, based on the size of each of the samples included in the first sampling group.

In embodiments, calculating the size of each of the samples may refer to calculating the second score through Equation 12.

In operation S156, the system 10 may reduce the unlabeled data pool UDP by removing the samples included in the second sampling group from the unlabeled data pool UDP.

In operation S157, the system 10 may expand the query dataset QDS by adding samples included in the second sampling group to the query dataset QDS.

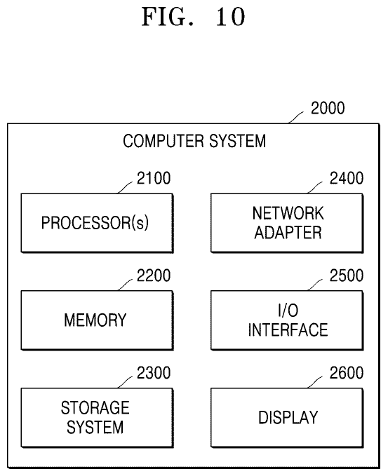

FIG. 10 is a block diagram of a computer system according to embodiments.

Referring to FIG. 10, a computer system 2000 may refer to any system including a general-purpose or special-purpose computing system. The computer system 2000 of FIG. 10 may correspond to the system 10 of FIG. 1. For example, the computer system 2000 may include personal computers, server computers, laptop computers, home appliances, and the like. As shown in FIG. 10, the computer system 2000 may include at least one processor 2100, a memory 2200, a storage system 2300, a network adapter 2400, an input/output (I/O) interface 2500, and a display 2600.

The at least one processor 2100 may execute a program module including computer system-executable instructions. The program module may include routines, programs, objects, components, logic, and data structures that perform specific tasks or implement specific abstract data types. The memory 2200 may include computer system-readable media in the form of volatile memory, such as random-access memory (RAM). The at least one processor 2100 may access the memory 2200 and execute instructions loaded into the memory 2200. The storage system 2300 may store information non-volatilely and may include at least one program product including a program module configured to perform the aforementioned active continual learning with reference to the drawings in some embodiments. The program may include, as a non-limiting example, an operating system, at least one application, other program modules, and program data.

The network adapter 2400 may provide connection to a local area network (LAN), a wide area network (WAN), and/or a public network (e.g., the Internet). The I/O interface 2500 may provide communication channels with peripheral devices, such as a keyboard, a pointing device, an audio system, and the like. The display 2600 may output various information to be viewed by a user.

In some embodiments, the active continual learning method described above with reference to the drawings may be implemented as a computer program product. The computer program product may include a non-transitory computer-readable medium (or storage medium) including computer-readable program instructions for causing the at least one processor 2100 to perform image processing and/or train models. The computer-readable instructions may include, as a non-limiting example, assembler instructions, instruction set architecture (ISA) instructions, machine instructions, machine-dependent instructions, micro-code, firmware instructions, state setting data, or source code or object code written in at least one programming language.

The computer-readable medium may be any type of medium capable of non-transitorily retaining and storing instructions executed by at least one processor 2100 or any instruction-executable device. The computer-readable medium may include, but is not limited to, an electronic storage device, a magnetic storage device, an optical storage device, an electromagnetic storage device, a semiconductor storage device, or any combination thereof. For example, the computer-readable medium may include a mechanically-encoded device, such as a portable computer disk, a hard disk, RAM, read-only memory (ROM), electrically erasable read-only memory (EEPROM), flash memory, static random-access memory (SRAM), a CD, a DVD, a memory stick, a floppy disk, a punch card, or any combination thereof.

While the disclosure has been particularly shown and described with reference to embodiments thereof, it will be understood that various changes in form and details may be made therein without departing from the spirit and scope of the following claims.

What is claimed is:

1. A method of sequentially training a neural network model with a plurality of unlabeled datasets corresponding to a plurality of tasks, respectively, performed by a computing system, the method comprising:
performing active continual learning for a first task based on a first unlabeled task dataset corresponding to the first task, a pretrained model parameter of the neural network model, and a memory dataset prestored in a memory buffer to update the model parameter and expand the memory dataset;
performing active continual learning for a second task based on a second unlabeled task dataset corresponding to the second task, the updated model parameter, and the expanded memory dataset; and
after active continual learning for each of the plurality of tasks is completed, outputting a final model parameter corresponding to the neural network model.

2. The method of claim 1, wherein the performing of the active continual learning for the first task comprises:
sampling a query dataset from the first unlabeled task dataset;
generating an unlabeled data pool based on the first unlabeled task dataset and the query dataset;
obtaining a labeled task dataset corresponding to the query dataset;
updating the model parameter by training the neural network model based on the labeled task dataset and the pretrained model parameter;
updating the model parameter, reducing the unlabeled data pool, and expanding the query dataset by performing active learning for the first task based on the model parameter, the prestored memory dataset, the unlabeled data pool, and the query dataset; and
expanding the memory dataset by storing, in the memory buffer, data obtained by labeling samples corresponding to the expanded query dataset.

3. The method of claim 2, wherein a size of the query dataset is less than a preset labeling budget.

4. The method of claim 2, wherein the performing of the active learning for the first task is repeatedly performed based on a preset number of active learning rounds.

5. The method of claim 2, wherein the expanding of the memory dataset comprises:
obtaining an expanded labeled task dataset corresponding to the expanded query dataset; and
expanding the memory dataset by storing the expanded labeled task dataset in the memory buffer.

6. The method of claim 2, wherein the performing of the active learning for the first task comprises:
calculating a first Fisher information embedding vector based on the model parameter and the memory dataset;
calculating a second Fisher information embedding vector based on the model parameter and the unlabeled data pool; and
calculating a target Fisher information embedding vector based on the first Fisher information embedding vector, the second Fisher information embedding vector, and a balancing parameter.

7. The method of claim 6, wherein:
elements of the first Fisher information embedding vector respectively correspond to diagonal components of a first Fisher information matrix defined by the model parameter and the memory dataset, and
elements of the second Fisher information embedding vector respectively correspond to diagonal components of a second Fisher information matrix defined by the model parameter and the unlabeled data pool.

8. The method of claim 6, wherein sizes of the first Fisher information embedding vector and the second Fisher information embedding vector correspond to a number of parameters corresponding to a final layer of the neural network model among parameters included in the model parameter.

9. The method of claim 6, wherein:
the balancing parameter is defined as a ratio of a size of unlabeled datasets at a past time point to a size of unlabeled datasets at a current time point,
the unlabeled datasets at the past time point correspond to past tasks prior to the first task, and
the unlabeled datasets at the current time point correspond to tasks up to the first task.

10. The method of claim 6, wherein the performing of the active learning for the first task further comprises:
generating a first sampling group by performing sampling, from the unlabeled data pool, based on a similarity between the target Fisher information embedding vector and each of samples included in the unlabeled data pool;
generating a second sampling group by performing sampling, from the first sampling group, based on a size of each of samples included in the first sampling group;
reducing the unlabeled data pool by removing samples included in the second sampling group from the unlabeled data pool; and
expanding the query dataset by adding samples included in the second sampling group to the query dataset.

11. The method of claim 6, wherein a final layer of the neural network model is a linear classification layer.

12. A system for sequentially training a neural network model with a plurality of unlabeled datasets corresponding to a plurality of tasks, respectively, the system comprising:
an active continual learning module configured to perform active continual learning for a first task based on a first unlabeled task dataset corresponding to the first task, a pretrained model parameter of the neural network model, and a memory dataset prestored in a memory buffer; and
a data management module configured to update the model parameter and expand the memory dataset by performing active continual learning for the first task,
wherein the active continual learning module is further configured to perform active continual learning for a second task based on a second unlabeled task dataset corresponding to the second task, the updated model parameter, and the expanded memory dataset, and output a final model parameter corresponding to the neural network model after active continual learning for each of the plurality of tasks is completed.

13. The system of claim 12, wherein:
the data management module is further configured to sample a query dataset from the first unlabeled task dataset, generate an unlabeled data pool based on the first unlabeled task dataset and the query dataset, and obtain a labeled task dataset corresponding to the query dataset,
the active continual learning module is further configured to update the model parameter by training the neural network model based on the labeled task dataset and the pretrained model parameter, and update the model parameter by performing active learning for the first task based on the model parameter, the prestored memory dataset, the unlabeled data pool, and the query dataset, and
the data management module is further configured to expand the memory dataset by reducing the unlabeled data pool and expanding the query dataset based on results of performing the active learning, and storing data corresponding to the expanded query dataset in the memory buffer.

14. The system of claim 12, wherein the data management module is further configured to obtain an expanded labeled task dataset corresponding to the expanded query dataset, and expand the memory dataset by storing the expanded labeled task dataset in the memory buffer.

15. The system of claim 12, wherein the active continual learning module is further configured to calculate a first Fisher information embedding vector based on the model parameter and the memory dataset, calculate a second Fisher information embedding vector based on the model parameter and the unlabeled data pool, and calculate a target Fisher information embedding vector based on the first Fisher information embedding vector, the second Fisher information embedding vector, and a balancing parameter.

16. The system of claim 15, wherein:
elements of the first Fisher information embedding vector respectively correspond to diagonal components of a first Fisher information matrix defined by the model parameter and the memory dataset, and
elements of the second Fisher information embedding vector respectively correspond to diagonal components of a second Fisher information matrix defined by the model parameter and the unlabeled data pool.

17. The system of claim 15, wherein sizes of the first Fisher information embedding vector and the second Fisher information embedding vector correspond to a number of parameters corresponding to a final layer of the neural network model among the parameters included in the model parameter.

18. The system of claim 15, wherein:
the balancing parameter is defined as a ratio of a size of unlabeled datasets at a past time point to a size of unlabeled datasets at a current time point,
the unlabeled datasets at the past time point correspond to past tasks prior to the first task, and
the unlabeled datasets at the current time point correspond to tasks up to the first task.

19. The system of claim 15, wherein:
the active continual learning module is further configured to generate a first sampling group by performing sampling, from the unlabeled data pool, based on a similarity between the target Fisher information embedding vector and each of samples included in the unlabeled data pool, and generate a second sampling group by performing sampling, from the first sampling group, based on a size of each of samples included in the first sampling group, and
the data management module is further configured to reduce the unlabeled data pool by removing samples included in the second sampling group from the unlabeled data pool, and expand the query dataset by adding samples included in the second sampling group to the query dataset.

20. A computer-readable non-transitory storage medium for storing instructions that, when executed by at least one processor, cause the at least one processor to sequentially train a neural network model with a plurality of unlabeled datasets corresponding to a plurality of tasks, respectively, the sequential training comprising:
performing active continual learning for a first task based on a first unlabeled task dataset corresponding to the first task, a pretrained model parameter of the neural network model, and a memory dataset prestored in a memory buffer to update the model parameter and expand the memory dataset;
performing active continual learning for a second task based on a second unlabeled task dataset corresponding to the second task, the updated model parameter, and the expanded memory dataset; and
outputting a final model parameter corresponding to the neural network model after active continual learning for each of the plurality of tasks is completed.
